(19) United States
(12) Patent Application Publication
(10) Pub. No.: US 2010/0273513 A1
(43) Pub. Date: Oct. 28, 2010

(54) MOBILE PHONE AND METHOD FOR SENDING MESSAGES USING THE MOBILE PHONE

(75) Inventor: SHIH-WEI HSU, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: Foxconn Communication Technology Corp., Taoyuan County (TW)

(21) Appl. No.: 12/582,821

(22) Filed: Oct. 21, 2009

(30) Foreign Application Priority Data
Apr. 27, 2009 (CN) 200910301888.1

(51) Int. Cl. H04W 4/12; H04M 1/00

(52) U.S. Cl. 455/466; 455/558

(57) ABSTRACT

A mobile phone includes a subscriber identity module (SIM) card, a SIM application toolkit (STK) driver, a STK interface and a user interface. The STK interface sends a selection command to the SIM card via the STK driver. The SIM card generates an input command according to the selection command, and sends the input command to the user interface via the STK driver. The user interface displays an input box on a display screen for receiving a user-inputted recipient phone number of a recipient mobile device according to the input command. The STK driver sends the multimedia messaging service (MMS) message to the recipient mobile device according to the recipient phone number if the message is an SMS message, and sends the short messaging service (SMS) message to the recipient mobile device according to the recipient phone number if the message is an MMS message.

### BACKGROUND

1. Technical Field

Embodiments of the present disclosure relate generally to methods for sending messages in a wireless network, and more particularly to a mobile phone and a method for sending messages using the mobile phone in a global system for mobile communications (GSM) network.

2. Description of Related Art

Short messaging service (SMS) has now become the most successful wireless data service in GSM networks. SMS allows a mobile device to transfer and receive text short messages of no more than 160 characters. In order to create more revenue from the GSM networks, a multimedia messaging service (MMS) offers a enhanced messaging service for transferring and receiving combinations of texts, pictures, audio and video. The MMS can be considered as extensions of GSM short message service, and provides message transmissions through the GSM networks by using mobile devices. However, each of the mobile devices may specify various instructions for sending SMS messages, but may not define the specifications for sending MMS messages among the mobile devices. In addition, it is a problem for the mobile device to determine if a message is an SMS messages or an MMS messages when the message is transferred through the GSM networks.

Accordingly, there is a need for an improved method for sending messages using a mobile phone in a GSM network, which can send SMS messages or MMS messages selectively, so as to overcome the above-mentioned problems.

### BRIEF DESCRIPTION OF THE DRAWINGS

FIG. 1 is a schematic diagram of one embodiment of a GSM mobile phone.

FIG. 2 including FIG. 2A and FIG. 2B is a flowchart of one embodiment of a method for sending messages by using the GSM mobile phone of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

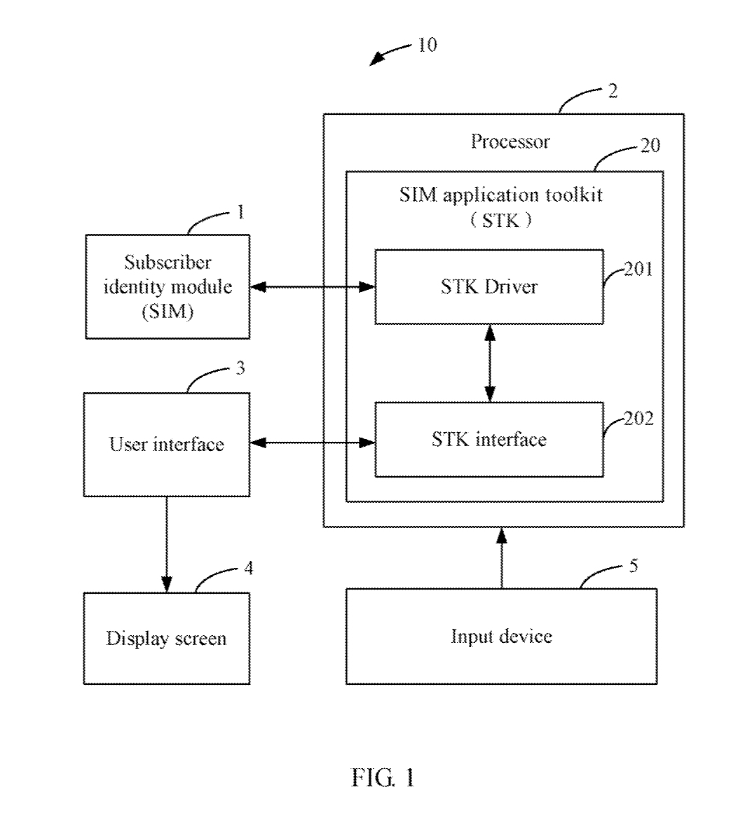

FIG. 1 is a schematic diagram of one embodiment of a global system for mobile communications (GSM) mobile phone 10. In one embodiment, the GSM mobile phone 10 includes a subscriber identity module (hereinafter “SIM card”) 1, a processor 2, and a user interface 3, a display screen 4, and an input device 5. The processor 2 is installed with an SIM application toolkit (hereinafter “STK”) 2, which may include an STK driver 21 and a STK interface 22. The SIM card 1 connects to the STK driver 21, and the user interface 3 connects to the STK interface 22. The user interface 3 may be displayed on the display screen 4, and provides a graphic operation interface for user to input messages. The input device 5 may be a keyboard, a keypad, or a touch panel. It should be apparent that FIG. 1 is only one example of an architecture for the GSM mobile phone 10 that can be included with more or fewer components than shown, or a different configuration of the various components. The GSM mobile phone 10 can send different type of messages through a GSM network. In the embodiment, the messages may be short messaging service (SMS) messages or multimedia messaging service (MMS) messages. The message content of the SMS messages may be text data, and the message content of the MMS messages that may be a combination of text data and multimedia data, such as pictures, audio, and video, for example.

The SIM card 1 stores a predefined instruction set for sending the SMS messages among the mobile devices through the GSM network, and generates a plurality of commands according to the predefined instruction set. The instruction set is typically predefined by a telecommunication service provider, such as China Mobile Communications or China Unicom, for example. When an SMS message and a recipient phone number (e.g., 136235600088) are received from the user interface 3 of the GSM mobile phone 10, the SIM card 1 generates an SMS sending command (e.g., Send_SMS command) according to the predefined instruction set, and sends the SMS sending command to the STK 2. After the STK 2 sends the SMS message to the recipient mobile device according to the recipient phone number, the SIM card 1 generates a session ending command (e.g., End_Sesssion command) to terminate the message sending process when the message has been relayed to the recipient mobile device successfully.

The STK 2 defines various commands (e.g., Send_SMS command) for sending SMS messages though the GSM network, but does not specifics the specifications for sending MMS messages though the GSM network. Therefore, the MMS messages cannot be sent by the GSM mobile phone 10 through the GSM network. In the embodiment of the present disclosure, the STK driver 21 of the STK 2 allows data communication between the SIM card 1 and the user interface 3 via the STK interface 22, so that the SMS messages and the MMS messages can be selectively sent by the GSM mobile phone 10.

The user interface 3 is operable to compose message content of an SMS message or an MMS message, create an input box to prompt for the recipient phone number, and display the input box on the display screen 4 after the message content is inputted from the input device 5. For example, the SIM card 1 sends an input command (e.g., a Get_Input command) to the STK driver 21 when an MMS message is inputted from the input device 5. The STK driver 21 sends the input command to the user interface 3 via the STK interface 22 when the STK driver 21 receives the input command from the SIM card 1, and then prompts for the recipient phone number in the input box of the display screen 4 according to the input command. The STK driver 21 sends the MMS message to the recipient mobile device according to the recipient phone number.

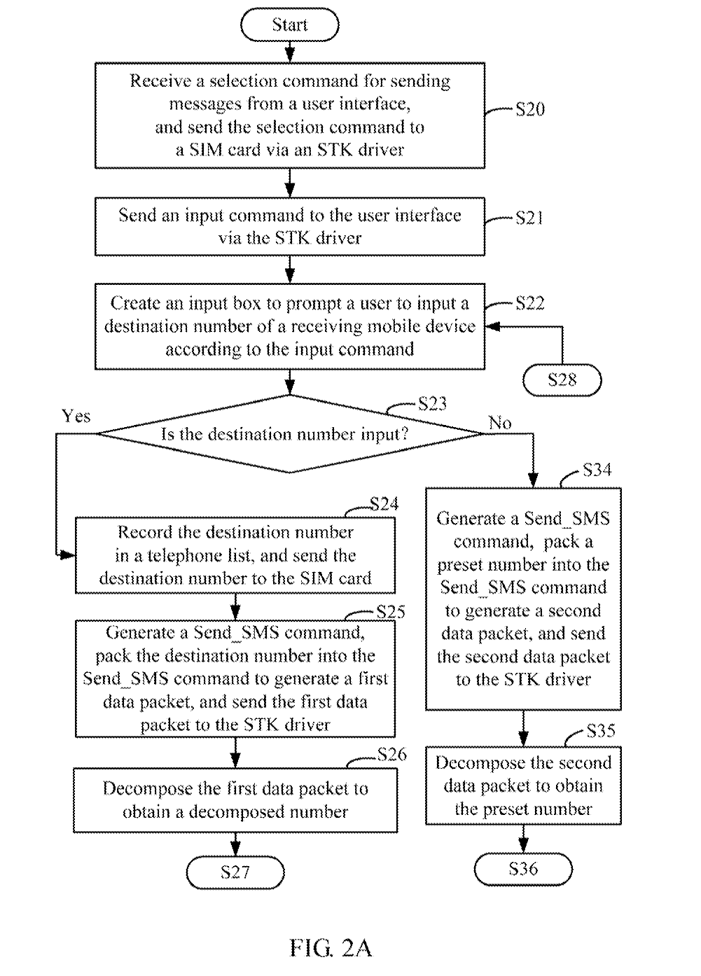

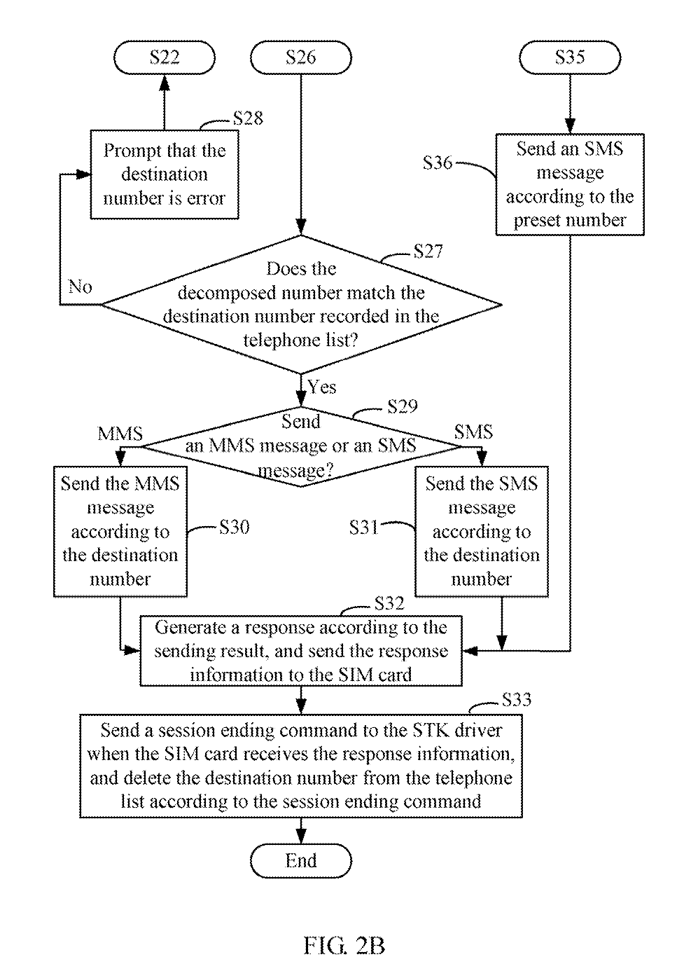

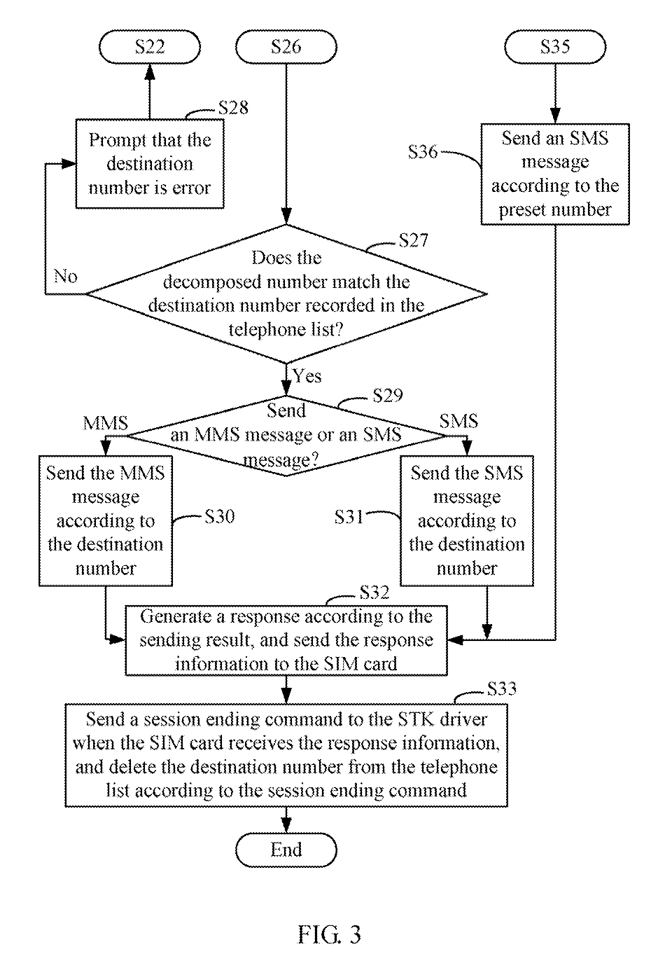

FIG. 2 including FIG. 2A and FIG. 2B is a flowchart of one embodiment of a method for sending MMS messages by the GSM mobile phone 10 as described in FIG. 1. Depending on the embodiment, additional blocks may be added, others removed, and the ordering of the blocks may be changed.

In block S20, the STK interface 22 receives a selection command for sending messages from the user interface 3 when a user inputs the selection command from the input device 5, and sends the selection command to the SIM card 1 via the STK driver 21. In one embodiment, the selection command may be used for determining if the message to be sent is an MMS message or an SMS message. For example, the user can input a Select_SMS command from the user interface 3 to send the SMS message to a recipient mobile device, or input a Select_MMS command from the user interface 3 to send the MMS message to the recipient mobile device.

In block S21, the SIM card 1 sends an input command (e.g., a Get_Input command) to the STK driver 21. The input command is used for requiring the user to input a recipient phone number of the recipient mobile device. In block S22, the STK driver 21 sends the input command to the user interface 3 via the STK interface 22 when the STK driver 21 receives the input command from the SIM card 1, and the user interface 3 creates an input box to prompt the user to input the recipient phone number according to the input command

In block S23, the STK interface 22 determines whether the recipient phone number is input from the user interface 3. If the recipient phone number is input from the user interface 3, in block S24, the STK interface 22 records the recipient phone number into a telephone list of the STK driver 21, and sends the recipient phone number to the SIM card 1 via the STK driver 21. Otherwise, if the recipient phone number is not input from the user interface 3, the procedure goes to block S34 as described below.

In block S25, the SIM card 1 generates a SMS sending command (e.g., Send SMS command) according to a predefined instruction stored in the SIM card 1 when the recipient phone number is received. The SIM card 1 packs the recipient phone number into the SMS sending command to generate a first data packet, and sends the first data packet to the STK driver 21. In block S26, the STK driver 21 decomposes the first data packet to obtain a decomposed telephone number when the first data packet is received, and compares the decomposed telephone number with the recipient phone number recorded in the telephone list.

In block S27, the STK driver 21 determines whether the decomposed telephone number matches the recipient phone number recorded in the telephone list. If the decomposed telephone number does not match the recipient phone number recorded in the telephone list, in block S28, the user interface 3 informs that the telephone number is error, then the procedure returns to block S22 to require the user inputs another recipient phone number from the input box of the user interface 3. Otherwise, if the decomposed telephone number matches the recipient phone number recorded in the telephone list, in block S29, the STK driver 21 determines whether the message is an MMS message or an SMS message by checking the message contents via the STK interface 22.

If the message is a MMS message, in block S30, the STK driver 21 sends the MMS message to the recipient mobile device according to the recipient phone number. Otherwise, if the message is a SMS message, in block S31, the STK driver 21 sends the SMS message to the recipient mobile device according to the recipient phone number. After the SMS message or the MMS message is sent, the STK driver 21 generates the message sending result that may indicate the message has been sent successfully or unsuccessfully.

In block S32, the STK driver 21 generates a response information according to the sending result, and sends the response information to the SIM card 1. In block S33, the SIM card 1 generates a session ending command (e.g., End_Session command) according to the predefined instruction set when the response information is received, and sends to the session ending command to the STK driver 21. The STK driver 22 deletes the recipient phone number from the telephone list and terminates the message sending process when the session ending command is received from the SIM card 1.

In block S23 as described above, if the recipient phone number is not input from the user interface 3, in block S34, the SIM card 1 generates a SMS sending command (e.g., Send_SMS command) according to a predefined instruction stored in a memory of the SIM card 1, and obtains a preset telephone number of the recipient mobile device from the memory. The SIM card 1 packs the preset telephone number into the SMS sending command to generate a second data packet, and sends the second data packet to the STK driver 21.

In block S35, the STK driver 21 decomposes the second data packet to obtain the preset telephone number when the second data packet is received. In block S36, the STK driver 21 sends an SMS message to the recipient mobile device according to the preset telephone number, and then the procedure goes to block S32 as described above.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile phone, comprising:
a subscriber identity module (SIM) application toolkit (STK) operable to send a selection command to a SIM card of the mobile phone via a STK driver in response to receiving a message inputted from a user interface of the mobile phone, wherein the selection command is used to check if a message to be sent is a multimedia messaging service (MMS) message or a short messaging service (SMS) message;
the SIM card being operable to generate an input command according to the selection command, and send the input command to the user interface via the STK driver;
the user interface being operable to display an input box on a display screen of the mobile phone for receiving a user-inputted recipient phone number of a recipient mobile device according to the input command; and
the STK driver being operable to determine whether the message is an MMS message or an SMS message according to the selection command, and send the SMS message to the recipient mobile device according to the recipient phone number if the message is an SMS message, or send the MMS message to the recipient mobile device according to the recipient phone number if the message is an MMS message.

2. The mobile phone according to claim 1, wherein the STK driver is further operable to determine whether the recipient phone number is received from the user interface, and send the SMS message to the recipient mobile device according to a preset number stored in the SIM card when the recipient phone number is not receive from the user interface.

3. The mobile phone according to claim 1, wherein the SIM card stores an instruction set predefined by a global telecommunication operator.

4. The mobile phone according to claim 1, wherein the STK driver controls the SIM card to communicate with the user interface via the STK interface.

5. The mobile phone according to claim 1, wherein the SMS message comprises text data.

6. The mobile phone according to claim 1, wherein the MMS message comprises a combination of text data and multimedia data.

7. A method for sending messages using a mobile phone in a global system for mobile communications (GSM) network, the mobile phone comprising a subscriber identity module (SIM) card, a SIM application toolkit (STK) driver, an STK interface and a display screen, the method comprising:
(a) receiving a selection command for sending a message from a user interface of the display screen;
(b) generating an input command when the SIM card receives a selection command from the STK driver;
(c) sending the input command to a user interface of the mobile phone via the STK interface when the STK driver receives the input command from the SIM card;
(d) displaying an input box on the display screen for receiving a user-inputted recipient phone number of a recipient mobile device according to the input command;
(e) determining whether the message to be sent is a multimedia messaging service (MMS) message or a short messaging service (SMS) message when the recipient phone number is received from the user interface;
(f) sending the SMS message to the recipient mobile device according to the recipient phone number if the message is an SMS message; and
(g) sending the MMS message to the recipient mobile device according to the recipient phone number if the message is an MMS message.

8. The method according to claim 7, after block (g) further comprising:
generating a response information when the message is sent to the recipient mobile device, and sending the response information to the SIM card; and
generating a session ending command to terminate the message sending process when the SIM card receives the response information from the STK driver.

9. The method according to claim 7, before block (e) further comprising:
recording the recipient phone number into a telephone list of the STK driver;
sending the recipient phone number to the SIM card via the STK driver;
generating an SMS sending command according to a predefined instruction set stored in the SIM card when the recipient phone number is received from the STK interface;
packing the recipient phone number into the SMS sending command to generate a first data packet;
decomposing the first data packet to obtain a decomposed telephone number when the first data packet is received from the SIM card;
determining whether the decomposed telephone number matches the recipient phone number recorded in the telephone list; and
informing that the recipient phone number is error and returning to block (d) if the decomposed telephone number does not match the recipient phone number recorded in the telephone list, or executing block (e) if the decomposed telephone number matches the recipient phone number recorded in the telephone list.

10. The method according to claim 7, further comprising:
generating an SMS sending command according to a predefined instruction set stored in the SIM card when the recipient phone number is not received from the user interface;
obtaining a preset telephone number of the recipient mobile device from the SIM card;
packing the preset telephone number into the SMS sending command to generate a second data packet;
decomposing the second data packet to obtain the preset telephone number when the second data packet is received; and
sending an SMS message to the recipient mobile device according to the preset telephone number.

11. The method according to claim 7, wherein the SMS message comprises text data.

12. The method according to claim 7, wherein the MMS message comprises a combination of text data and multimedia data.

13. A computer readable medium having stored thereon instructions that, when executed by a mobile phone, cause the mobile phone to perform a method for sending messages in a GSM network, the method comprising:
(a) receiving a selection command for sending a message from a user interface of the mobile phone;
(b) generating an input command when a SIM card of the mobile phone receives the selection command from a STK driver of the mobile phone;
(c) sending the input command to the user interface via a STK interface of the mobile phone when the STK driver receives the input command from the SIM card;
(d) displaying an input box on a display screen of the mobile phone for receiving a user-inputted recipient phone number of a recipient mobile device according to the input command;
(e) determining whether the message to be sent is a multimedia messaging service (MMS) message or a short messaging service (SMS) message when the recipient phone number is received from the user interface;
(f) sending the SMS message to the recipient mobile device according to the recipient phone number if the message is an SMS message; and
(g) sending the MMS message to the recipient mobile device according to the recipient phone number if the message is an MMS message.

14. The medium according to claim 13, wherein after block (g) the method further comprises:
generating a response information when the message is sent to the recipient mobile device, and sending the response information to the SIM card; and
generating a session ending command to terminate the message sending process when the SIM card receives the response information from the STK driver.

15. The medium according to claim 13, wherein before block (e) the method further comprises:
recording the recipient phone number into a telephone list of the STK driver;
sending the recipient phone number to the SIM card via the STK driver;
generating an SMS sending command according to a predefined instruction set stored in the SIM card when the recipient phone number is received from the STK interface;
packing the recipient phone number into the SMS sending command to generate a first data packet;
decomposing the first data packet to obtain a decomposed telephone number when the first data packet is received from the SIM card;
determining whether the decomposed telephone number matches the recipient phone number recorded in the telephone list; and
informing that the recipient phone number is error and returning to block (d) if the decomposed telephone number does not match the recipient phone number recorded in the telephone list, or executing block (e) if the decomposed telephone number matches the recipient phone number recorded in the telephone list.

16. The medium according to claim 13, wherein the method further comprises:
generating an SMS sending command according to a predefined instruction set stored in the SIM card when the recipient phone number is not received from the user interface;
obtaining a preset telephone number of the recipient mobile device from the SIM card;
packing the preset telephone number into the SMS sending command to generate a second data packet;
decomposing the second data packet to obtain the preset telephone number when the second data packet is received; and
sending an SMS message to the recipient mobile device according to the preset telephone number.

17. The medium according to claim 13, wherein the SMS message comprises text data.

18. The medium according to claim 13, wherein the MMS message comprises a combination of text data and multimedia data.
